(19) United States
(12) Patent Application Publication
(10) Pub. No.: US 2013/0095313 A1
(43) Pub. Date: Apr. 18, 2013

(54) METHOD FOR INHIBITING CORROSION UNDER INSULATION ON THE EXTERIOR OF A STRUCTURE

(71) Applicants: Shiun Ling, Houston, TX (US); Brian Joseph Fitzgerald, Kingwood, TX (US); James Edward Feather, Burke, VA (US)

(72) Inventors: Shiun Ling, Houston, TX (US); Brian Joseph Fitzgerald, Kingwood, TX (US); James Edward Feather, Burke, VA (US)

(73) Assignee: EXXONMOBIL RESEARCH AND ENGINEERING COMPANY, Annandale, NJ (US)

(21) Appl. No.: 13/272,668

(22) Filed: Oct. 13, 2011

(51) Int. Cl. B32B 3/26; B65D 90/00; C21D 6/00; B32B 17/06; C22C 38/18; C22C 38/00; F16L 9/02; B32B 15/04

(52) U.S. Cl. 428/312.6; 138/177; 206/524.6; 428/319.1; 428/221; 428/433; 428/450; 420/8; 420/115; 148/333; 148/660

(57) ABSTRACT

A method for inhibiting corrosion under insulation (CUI) on the exterior of a structure, e.g., pipelines, piping, vessels and tanks, is provided. The method involves providing a structure that is at least partially formed from a corrosion resistant carbon steel (CRCS) composition. The CRCS composition includes corrosion resistance alloying additions in the amount of 0.1 weight percent to 9 weight percent. At least one alloying addition has a low free energy of formation for its oxide and/or hydroxide, e.g., vanadium and/or titanium. A corrosion inhibited structure that includes a structure at least partially formed from a corrosion resistant carbon steel (CRCS) composition, and insulation positioned around at least a portion of the structure.

### FIELD

This disclosure relates to a method for inhibiting corrosion under insulation (CUI) on the exterior of a structure, pipelines, piping, vessels and tanks. The method involves providing a structure that is at least partially formed from a low alloy steel composition that has improved corrosion resistance, which is also known as corrosion resistant carbon steel (CRCS). The composition useful in this disclosure includes corrosion resistance alloying additions in the amount of 0.1 weight percent to 9 weight percent.

### BACKGROUND

Corrosion under insulation (CUI) can occur on structures that are thermally insulated and exposed to the weather. Such insulated structures may include, but is not limited to, pipelines, piping, vessels, tanks or other equipment. The CUI problem begins when there is a breach in the insulation or in an outer jacketing protecting the insulation. Moisture in various forms, e.g., rain, melting snow or condensation from humid air, can then penetrate the jacketing and wet the insulation, or enter directly into the space between the insulation and the vessel or pipe. Liquid water will eventually contact the external surface of the structures beneath the insulation. Corrosion will occur if the structures are made of non-corrosion-resistant metals, such as carbon steels or low alloy steels, and no coating was applied to protect its exterior surface, or a coating was applied but had deteriorated.

Depending on the amount of water present, availability of oxygen, and temperature of the metal surface, CUI can be mildly aggressive: up to 60 mils per year (0.060 inches per year) wall loss has been observed. Higher corrosion rates may be observed if other corrosives in the atmosphere are dissolved in the water under the insulation.

In general, CUI is insidious and often there are no visible external signs that such corrosion is occurring. This is because CUI takes place underneath insulation that blocks direct observation. There is no cost effective way to detect CUI, short of stripping off the insulation for direct inspection, which is a laborious and costly undertaking. As a result, the first indication of CUI is often the failure of the insulated pipeline, piping, vessel, or tank, and the failures due to CUI are usually sudden and may occur over a sizeable surface area.. In other words, CUI can lead to failure in the structure before the corrosion is discovered and thus before measures can be taken to repair the damage. The consequences of the failure can be significantly more severe if the contents of the structures are under pressure.

The insidious nature of CUI is in strong contrast to other forms of corrosion (e.g. internal corrosion and atmospheric corrosion), which in general can be observed and monitored, and thus allow a warning to be raised in sufficient time for appropriate responses before the corrosion damage becomes too severe. For this reason, CUI is a more serious safety and environmental concern than other forms of corrosion.

CUI is currently managed by following design and maintenance best-practices to minimize water infiltration. Nevertheless, water infiltration is often inevitable and numerous instances of CUI are detected every year.

When CUI is found, the wet insulation is removed, the corrosion product cleaned off the structure, and the damage is measured and evaluated. If the damage is not too severe, the structure is covered with a protective coating or wrapping (such as a plastic tape designed for buried pipeline applications) and then reinsulated. If the damage is too severe, the metal is either replaced or reinforced, such as using a designed sleeve installed over the damaged area before applying the protective wrap. This reconditioning can be expensive.

For a new structure, a way of eliminating CUI is to construct the structure using more expensive corrosion resistant alloys. This approach, however, will incur significantly higher material cost than if low cost steels are used. Another way is to coat or paint the bare structure before it is insulated. This would provide CUI protection mainly by keeping the structure from coining into direct contact with the liquid water and the resulting corrosion. However, this approach adds 5% to the cost of constructing a new structure. Even in those cases where coatings are applied, the integrity of the coatings can be highly variable for various reasons related to coating selection, surface preparation, and coating application methods, all of which can render the coating and insulation system unreliable. Thus, coating or painting the structure for CUI protection has been rejected at times in the past as too expensive.

Therefore, there is a need in the art for an effective method for mitigating CUI that is not costly, laborious or time consuming. A material solution to circumvent occurrence of CUI as described in the present disclosure would be highly desirable.

The present disclosure also provides many additional advantages, which shall become apparent as described below.

### SUMMARY

This disclosure provides a material solution to circumvent the occurrence of CUI. This disclosure also provides a method for mitigating CUI that is not costly, laborious or time consuming.

This disclosure relates in part to a method for inhibiting CUI on the exterior of a structure. The method comprises providing a structure that is at least partially formed from a CRCS composition. The CRCS composition comprises corrosion resistance alloying additions in the amount of 0.1 weight percent to 9 weight percent,

This disclosure also relates in part to a corrosion inhibited structure that comprises a structure at least partially formed from a CRCS composition, and has insulation positioned around at least a portion of the structure. The CRCS composition comprises corrosion resistance alloying additions in the amount of 0.1 weight percent to 9 weight percent.

Further objects, features and advantages of the present disclosure will be understood by reference to the following drawings and detailed description.

### BRIEF DESCRIPTION OF THE DRAWINGS

FIG. 1 is an exemplary thermodynamic phase diagram of a vanadium containing CRCS composition calculated using Thermo-Calc™ computer model in accordance with aspects of the present disclosure.

FIG. 2 graphically depicts instantaneous corrosion rates exemplified in the examples herein.

### DETAILED DESCRIPTION

All numerical values within the detailed description and the claims herein are modified by “about” or “approximately” the indicated value, and take into account experimental error and variations that would be expected by a person having ordinary skill in the art.

This disclosure describes the resistance of CRCS materials to CUI. CRCS materials are low alloy steels that are based on conventional carbon steel chemistry, but with relatively small additions of specific alloying elements (e.g., vanadium) to improve the corrosion resistance. CRCS materials are useful in applications where corrosion by CO₂ and low level H₂S are of concern. The present disclosure relates to applications where there is a concern of CUI. The CRCS materials of this disclosure exhibit superior performance over commercially available carbon and low alloy steels for CUI applications. The cost of these CRCS materials is significantly below that of conventional corrosion resistant alloys.

CUI is one of the leading causes of deterioration of the structures used in oil and gas production operations, refineries and chemical plants. This type of corrosion occurs on steels that are covered by a layer of insulation. The insulation is generally applied for thermal insulation purpose. It is typically made of non-thermal conducting materials, porous and non-porous, that may wick or absorb water. The insulation layer can undesirably create an annular space or crevice between the insulation layer and the surface of the steel structure underneath, which can facilitate the retention of water. The insulation can come in contact with water either due to direct exposure to external sources such as rain, cooling tower drift, wash downs, etc. or due to condensation when the metal surface temperature drops below the dew point. CUI occurs when this water comes into contact with the steel surface.

As indicated above, currently there is no reliable technology to detect the occurrence of CUI, with the exception of stripping off the insulation followed by visual inspection, which can be costly, laborious and time consuming. As such, CUI is also considered to be an insidious form of corrosion. There have been attempts to prevent the infiltration of external water with an additional layer of water tight wrapping. This approach, however, has not been successful, because over time these water tight layers are frequently damaged resulting in water ingress, or are breached causing water vapor ingress. In mitigating CUI, utilizing CRCS materials in accordance with this disclosure provides a desired economic mitigation approach. Use of CRCS materials described in this disclosure can reduce occurrence of CUI, and hence reduce the maintenance and project costs. Beneficially, the CRCS compositions provide enhanced resistance to CUI. These CRCS compositions provide an appropriate balance of cost and corrosion resistance (under insulation) performance.

Illustrative structures useful in this disclosure for which CUI can be inhibited include, for example, pipelines, pipings, vessels, tanks and other equipment capable of being covered at least in part with insulation. The fabrication and use of such pipelines, pipings, vessels, tanks and other equipment is well known. Similarly, various methods for making and installing the pipelines, pipings, vessels, tanks and other equipment, as well as methods for covering the pipelines, pipings, vessels, tanks and other equipment with insulation, are known to those skilled in the art.

The insulation useful in this disclosure includes any insulation suitable for covering a structure. The insulation can cover the structure partially or totally. Illustrative insulation useful in this disclosure includes, for example, foam insulation, closed cell foam insulation and fibrous insulation. Examples of insulation include aerogels, cellular glass, mineral wool, and calcium silicate insulation. In an embodiment, the foam insulation is polyurethane foam. In another embodiment, a cover can be positioned over the outside of the insulation. For example, the structure can be a pipeline and a cover can be positioned over the outside of the insulation on the pipeline.

The CRCS compositions useful in this disclosure include a class of low alloy steels, which can be made to have beneficial surface properties of the desired corrosion resistance through relatively small additions of specific alloying elements, for example, vanadium. The vanadium addition imparts the desired corrosion resistance and enhanced resistance to CUI to the steel, via the formation of protective surface layers of oxide-hydroxide that are enriched in vanadium to levels higher than that in the nominal steel compositions. This protective surface oxide-hydroxide layers can reduce the kinetics of the surface electrochemical reactions that underlie the corrosion processes. The ability of the vanadium to form such protective layer is because of its relatively low free energy of formation for its oxide and/or hydroxide. Accordingly, other alloying additions of relatively low free energy of formation for their oxide-hydroxide, e.g. titanium, may also be useful in similar application as the alloying addition to impart corrosion resistance and CUI resistance to the steels.

The CRCS compositions useful in this disclosure can be made to provide beneficial CUI resistance, strength and toughness properties. The low alloyed nature of the CRCS compositions will provide the desired weldability. However, to achieve the mechanical property targets, the steels need to be further enhanced with appropriate metallurgical processings, which may include but are not limited to thermal and/or thermomechanical treatments, to produce suitable strong and tough microstructures. The CRCS composition preferably includes vanadium in an amount of 0.1 weight percent to 9 weight percent, carbon in an amount of 0.03 weight percent to 0.45 weight percent, manganese in an amount up to 2 weight percent, and silicon in an amount less than 0.45 weight percent. See, for example, WO 2008/156526, the disclosure of which is incorporated herein in its entirety.

The suitable microstructures for CRCS compositions may include, but are not limited to, ones that comprise of predominantly ferrite phase (α phase), or predominantly martensite phase (α′ phase), or predominantly tempered martensite phase (T-α′ phase), or predominantly dual phase, where the dual phase may be either ferrite and martensite phases (α+α phases), or ferrite and tempered martensite phases (α+T-α′ phases). Additionally, the above mentioned ferrite, martensite, tempered martensite and dual phase microstructures may be further strengthened with second phase precipitates.

The term “predominant” as used herein to describe the microstructure phases indicates that the phase, or phase mixture in the case of dual phase, exceeds 50 volume percent (volume %) in the steel microstructure. The volume percent is approximated to area percent (area %) obtained by standard quantitative metallographic analysis such as using optical microscope micrographs or using Scanning Electron Microscope (SEM) micrographs. To arrive at the area %, as an example, without limiting this disclosure, the following procedure may be used: select randomly a location in the steel, take 10 micrographs at 500 times (×) magnification in an optical microscope or 2000× magnification in an SEM from adjacent regions of this location of metallographic sample prepared by standard methods known to those skilled in the art. From the montage of these micrographs, calculate the area % of the phases using a grid or similar such aid and this area is reported as the volume %. To calculate the area %, automated methods through setting the gray scale and automatically computing the area % of the phases above and below the gray scale may also be used.

As an example, the above mentioned beneficial microstructures for the CRCSs may be produced through a general heat treatment process. In this process, the CRCS compositions are first heated to an appropriately high temperature and annealed at that temperature for sufficiently long time to homogenize the steel chemistry and to induce phase transformations that convert the steels to, depending on the specific steel compositions, either essentially austenite phase or essentially a mixture of austenite and ferrite phases, or essentially ferrite phase. The phase transformations occurred via nucleation and growth processes, which result in the new phases to form in small grains. These newly formed small grains, however, can grow with increasing time if the steels are held at the annealing temperature. The grain growth may be stopped coo ling the steels down to appropriately low temperature.

The CRCS compositions may then be quenched at an appropriately fast cooling rate to transform most of the austenite phase to the strong and hard martensite phase. The ferrite phase, if present, is not affected by this fast cooling step. Cooling in air may also be used because it may provide a sufficiently fast cooling rate for certain steel compositions, as well as having the economic benefit of being a lower cost operation. After quenching, the CRCS compositions may then be subjected to tempering by reheating to an appropriate temperature and keeping at that temperature for sufficiently long time to improve the toughness properties. After these heat treatments, the final CRCS microstructures are ones that comprise either predominantly ferrite (α), or predominantly martensite (a′), or predominantly tempered martensite (T-α′), or predominantly dual phases that are strong and tough.

In the above described CRCS heat treatments and processings, additional processing steps may be employed to achieve further enhancements in mechanical performance. As an example, this may be achieved by including the previously described thermomechanical working of annealed CRCS compositions during the quenching steps. Alternatively, this may also be achieved after annealing by adding one or more of the previously described thermal cycling steps, such that in each thermal cycling step the CRCS composition is reheated to an appropriate temperature that is not higher than its original annealing temperature.

Further, specific adjustment of processing parameters (e.g., heating temperature and duration) may be performed to accommodate specific CRCS compositions, as is commonly practiced in the steel industry. For instance, the CRCS compositions may be fine tuned, and the associated quenching and tempering parameters (i.e., soaking time and temperature) may be accordingly adjusted to obtain the desired candidate microstructures and their mechanical performance. The candidate microstructures include those described previously, the ones that comprise predominantly the martensite (as-quenched and tempered); dual ferrite-martensite phase (as-quenched and tempered); and additional microstructures.

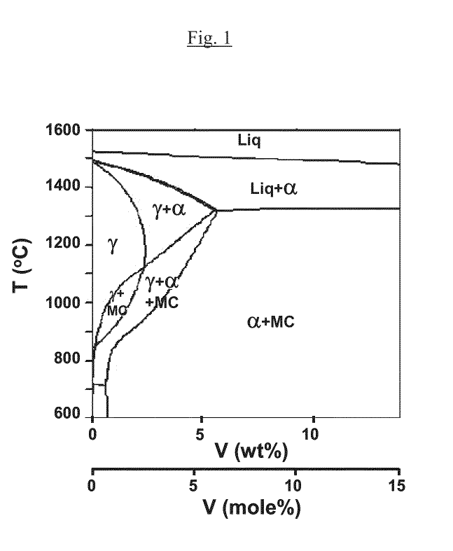

The metallurgical processing steps suitable for the CRCS compositions and the resulting microstructures are discussed further below. The effectiveness and the resulting microstructure of these processing steps, however, are strongly affected by the CRCS compositions. Those skilled in the art may use appropriate thermodynamic phase diagrams to generate information on the relationship among the CRCS compositions, the suitable processing steps and the resulting microstructures, and thus to design the metallurgical processing steps in order to achieve the desired beneficial bulk mechanical properties. As an example, FIG. 1 shows a thermodynamic phase diagram generated using the Thermo-Calc™ computer model for a vanadium containing CRCS composition, Fe+xV at %+(0.5Mn-0.1Si-0.15C w %). The phase diagram shows the regimes of various stable metallurgical phases, including the austenite phase (γ), ferrite phase (α), metal-carbide phase (MC) and liquid phase (Lig). It is noted that the phase diagram does not show the martensite (α′) nor the tempered martensite (T-α′) phases. This is because these are meta-stable phases thus cannot be placed in the thermodynamic phase diagram.

Those skilled in the art may use thermodynamic phase diagram to design the metallurgical processing steps to achieve desired steel microstructure for bulk mechanical properties. As an example, from FIG. 1, a CRCS composition having V addition of less than 2.5 weight percent can be completely phase transformed into austenite phase via annealing the steel at appropriate high temperature in the austenite stability regime for sufficiently long time. According to FIG. 1, suitable annealing temperature is in the range from 850° C. to 1450° C. Preferably, the annealing temperature is above the upper temperature boundary of the metal-carbide stability regime to dissolve the carbide precipitates for homogenizing the steel composition. Suitable annealing time is up to 24 hours. The steel can subsequently be quenched to transform the austenite phase into the strong martensite phase microstructure. The steel can then be reheated to below the lower temperature boundary of the austenite regime to temper the martensite phase for improved toughness. Suitable tempering temperature from FIG. 1 is in the range from 400° C. to the lower boundary of austenite formation temperature. Suitable tempering time is up to 12 hours.

As another example, a CRCS composition having V addition of between 2.5 weight percent and less than 6 weight percent can be partially phase transformed into an austenite+ferrite mixture phases (i.e., γ+α) via annealing the steel at appropriate high temperature in the austenite+ferrite stability regime for sufficiently long time, preferably at temperature above that of the metal-carbide stability regime. The steel can subsequently be quenched to transform the austenite phase to martensite phase to achieve a martensite+ferrite dual phase microstructure, where the strong martensite phase provides the strength and the softer ferrite phase provides the toughness. The steel can then be reheated to below the austenite regime to temper the martensite phase.

As yet another example, a CRCS composition having V addition of 4 weight percent can be partially phase transformed into a half-half austenite+ferrite mixture phases at appropriate high temperature, preferably at temperature above that of the metal-carbide stability regime. The steel can subsequently be quenched to achieve a martensite+ferrite dual phase microstructure, with 50 volume percent of the martensite phase and 50 volume percent of the ferrite phase. The steel can then be reheated to below the austenite regime to temper the martensite phase.

The CRCS compositions have broad industrial applicability. In particular, these low alloy steels provide an economic alternative to the highly alloyed steels or inhibition technologies used for corrosion control in many applications. As such, this disclosure describes the composition of the low alloy steels, steel processing and fabrication of the precursor steel into useful shapes for specific applications that exhibit enhanced CUI resistance.

The CRCS compositions are iron-based steels designed to impart and enable both the surface corrosion resistance and bulk mechanical properties within the performance levels, which are produced through a combination of alloying elements, heat treatments and processing. In one or more embodiments, the CRCS composition consists essentially of iron, corrosion resistance alloying elements, and one or more other alloying elements. Minor amounts of impurities may be allowed per conventional engineering practice. Without limiting this disclosure, said impurities or minor alloying may include S, P, Si, O, Al, etc. As such, the CRCS composition may include a total of up to 9 weight percent of alloying additions. The roles of the various alloying elements and the preferred limits on their concentrations for the present disclosure are discussed herein.

For the corrosion resistance alloying additions, the CRCS compositions can include vanadium (V) to provide corrosion resistance and enhanced inhibition of CUI on the exterior of a structure. The addition of the. V corrosion resistance alloying additions to the basic steel along with other alloying additions can provide enhanced inhibition of CUI in comparison to carbon steels without the alloying elements. As described herein, other alloying additions of relatively low free energy of formation for their oxide-hydroxide, e.g. titanium, may also be useful in similar application as the alloying addition to impart corrosion resistance and CUI resistance to the steels. Mixtures of such alloying additions having low free energy of formation for their oxide-hydroxide can also be useful in this disclosure.

For example, one or more embodiments of the CRCS compositions may include an amount of V in the range of 0.1 weight percent to 9 weight percent to provide enhanced CUI resistance. From the phase diagram shown in FIG. 1, the preferable amount of V addition is in the range of 0.1 weight percent to 6 weight percent, where the V addition is more than the 0.1 weight percent lower limit to impart resistance to CUI, and less than the 6 weight percent upper limit for processability to produce suitable microstructures that provide bulk mechanical performance. To further improve the CRCS microstructures to ones that contain more than 50 volume-percent (volume percent) of the strong martensite or tempered martensite phases for enhanced bulk mechanical properties, the amount of ⁻V addition is more preferably in the range of 0.1 weight percent to 4 weight percent, even more preferably in the range of 1 weight percent to 2.5 weight percent, and most preferably in the range of 1.5 weight percent to 2.5 weight percent

In addition to the corrosion resistance under insulation alloying additions or elements, other suitable alloying elements may be included to enhance and/or enable other properties of the CRCS compositions. Nonlimiting examples of these additional alloying elements may include, for example, carbon, manganese, silicon, niobium, chromium, nickel, boron, nitrogen, and combinations thereof The CRCS compositions may include, for example, additional alloying elements that enable the base steel to be processed for improved bulk mechanical properties, such as higher strength and greater toughness As such, these alloying elements are combined into the CRCS compositions to provide and/or enable adequate mechanical properties for certain structural steel applications.

Certain alloying elements and preferred ranges are described herein. In one or more embodiments, the CRCS compositions include carbon (C). Carbon is one of the elements used to strengthen and harden steels. Its addition also provides some secondary benefits. For example, carbon alloying addition stabilizes austenite phase during heating that can form harder and stronger lath martensite microstructure in CRCS compositions with appropriate cooling treatment. Carbon can also combine with other strong carbide forming elements in the CRCS compositions, such as niobium (Nb) and V to form fine carbide precipitates that provide precipitation strengthening, as well as inhibit grain growth during processing to enable fine grained microstructure for improved toughness at low temperature. To provide these benefits, carbon is added to CRCS compositions at an amount between 0.03 weight percent and 0.45 weight percent, preferably in the range between 0,03 weight percent and 0,25 weight percent, more preferably in the range between 0.05 weight percent and 0.2 weight percent, and even more preferably in the range between 0.05 weight percent and 0.12 weight percent.

In one or more embodiments, the CRCS compositions may include manganese (Mn), Manganese is also a strengthening element in steels and can contribute to hardenability. However, too much manganese may be harmful to steel plate toughness As such, manganese may be added to the CRCS composition up to an amount of no more than 2 weight percent, preferably in the range of 0.5 weight percent to 1.9 weight percent, or more preferably in the range of 0,5 weight percent to 1.5 weight percent,

In one or more embodiments, the CRCS compositions may include silicon (Si). Silicon is often added during steel processing for de-oxidation purposes. While it is a strong matrix strengthener, it nevertheless has a strong detrimental effect that degrades the steel toughness. Therefore, silicon is added to CRCS composition at an amount less than 0.45 weight percent

In one or more embodiments, the CRCS compositions may include chromium (Cr). In addition to providing enhanced weight loss corrosion resistance, Cr additions strengthen the steel through its effect of increasing the hardenability of the steel. However, as stated above, Cr additions may lead to susceptibility to pitting corrosion in aqueous environments that contain oxygen. The disclosed steels containing V and Cr can provide simultaneously both CUI resistance as well as weight loss corrosion resistance. This dual corrosion resistance benefit is provided by adding V with Cr so that the net addition is in the range of 0.1 weight percent to 9 weight percent. To improve the processability of the steel for the bulk mechanical property requirements of the target applications, however, the net amount of V with Cr addition is preferably in the range of 1 weight percent to 3.5 weight percent, and more preferably in the range of 1.5 weight percent to 3 weight percent, and even more preferably in the range of 2 weight percent to 3 weight percent

In one or more embodiments, the CRCS compositions may include nickel (Ni). Nickel addition may enhance the steel processability. Its addition, however, can degrade the corrosion resistance property, as well as increase the steel cost. Yet, because Ni is an austenite stabilizer, its addition may allow more V addition to offset the negative impact on the corrosion resistance properties. To improve steel processability, Ni is added in an amount less than 3 weight percent, and preferably less than 2 weight percent.

in one or more embodiments, the CRCS compositions may include boron (B). Boron can greatly increase the steel hardenability relatively inexpensively and promote the formation of strong and tough steel microstructures of lower bainite, lath martensite even in thick sections (greater than 16 mm) However, boron in excess of 0.002 weight percent can promote the formation of embrittling particles of Fe₂₃(C₃B)₆. Therefore, when boron is added, an upper limit of 0.002 weight percent boron is preferred. Boron also augments the hardenability effect of molybdenum and niobium.

In one or more embodiments, the CRCS compositions may include niobium (Nb). Nb can be added to promote austenite grain refinement through formation of fine niobium carbide precipitates that inhibit grain growth during heat treatment, which includes at least 0.005 weight percent Nb. However, higher Nb can lead to excessive precipitation strengthening that degrades steel toughness, hence an upper limit of 0.05 weight percent Nb is preferred. For these reasons, Nb can be added to CRCS in the range of 0.005 weight percent to 0.05 weight percent, preferably in the range of 0.01 weight percent to 0.04 weight percent.

Further, sulfur (S) and phosphorus (P) are impurity elements that degrade steel mechanical properties, and may be managed to further enhance the CRCS compositions. For example, S content is preferably less than 0.03 weight percent, and more preferably less than 0.01 weight percent. Similarly, P content is preferably less than 0.03 weight percent, and more preferably less than 0.015 weight percent.

This disclosure includes (a) a range of CRCS compositions that enhance inhibition of CUI on the exterior of a structure, (h) metallurgical processing and the resulting strong and tough microstructure of the CRCS, and (c) the use of CRCS to make low cost structures with enhanced inhibitions to CUI for a variety of applications. The CRCS compositions may be utilized in a variety of applications that require insulation covering a structure in particular, the CRCSs may be utilized for structures including pipelines, piping, vessels and tanks that require a insulation cover. The insulated equipment may be utilized in various applications in oil and gas productions, refineries and chemical plants.

Conventional corrosion control technologies for mitigating CUI typically rely upon either coating or painting the carbon steel structure, or to make the structure out of corrosion resistant alloys. Both approaches will incur additional costs. Accordingly, the addition of small amounts of V to the basic steel along with other alloying additions can provide enhanced inhibition of CUI in comparison to other carbon steels at low cost. As such, one of the distinguishing aspects of the present disclosure is the use of the CUI resistance property enhancements provided by the V alloying additions.

For structural applications, the CRCS materials can be made to have beneficial bulk mechanical properties, including specific strength and toughness properties. This is accomplished through metallurgical processing steps that are suitable for specific CRCS compositions. Such metallurgical processing steps may include, but are not limited to, heat treatments and/or thermo-mechanical treatments. The effectiveness and the resulting microstructures of these processing steps, however, are strongly affected by the CRCS compositions. The CRCS compositions can be further designed for the purpose of producing the beneficial bulk mechanical properties, in addition to the already mentioned beneficial surface corrosion resistance under insulation properties.

The CRCS materials can be selected to form CRCS equipment that can be covered with insulation to inhibit corrosion under insulation as well as mechanical performance. The low alloyed nature of the CRCS compositions will provide the desired weldability, which facilitate the fabrication of desired structures out of CRCSs. Beneficially, the steel having a CRCS composition may be used to form CRCS equipment that is insulated for particular applications. The can reduce operating costs associated with corrosion control, as well as to reduce the high initial capital expenses associated with making the equipment out of high cost corrosion resistant alloys.

### EXAMPLES

CRCS materials were shown through lab test to have superior resistance to CUI as compared to base case commercially available carbon and low alloy steels.

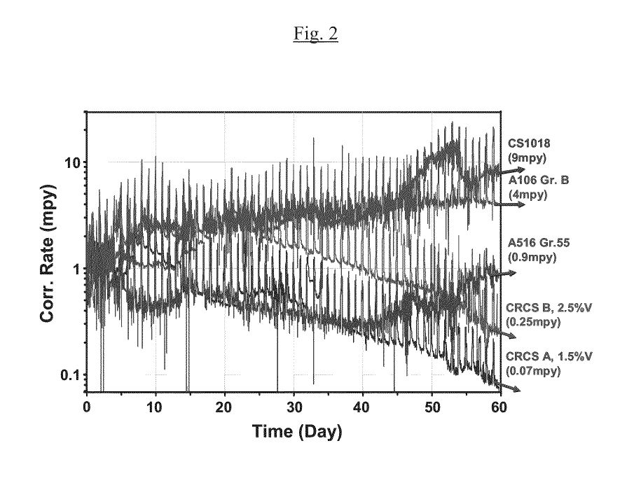

Two different compositions of CRCS materials with 1.4 weight percent V and 2.3 weight percent V were tested for CUI performance against three commercial steels for reference—AISI 1018 carbon steel, ASTM A106 Grade B (carbon steel piping grade), and ASTM A516 Grade 55 (carbon steel pressure vessel grade). The composition of the materials is shown in Table I. The tests were conducted using standard procedures in ASTM Standard G189-07 procedure which comprised of exposure of the materials under insulation to cycles of wet (dilute brine solution, 180° F., 20 hours) and dry (230° F., 4 hours) environments for a total period of 60 days. The performance of the steels was evaluated by tracking the in-situ instantaneous corrosion rates using Linear Polarization Resistance (LPR) technique, and by estimating the average corrosion rates at the end of the test. The latter was also estimated from weight-loss measurements. The results from the test are shown in FIG. 2 (instantaneous corrosion rates) and Table 2 (average corrosion rates). For the corrosion rates, “mpy” indicates mils per year.

TABLE 1
Steel compositions.

| | Composition (wt %) | | | | | | | | | | | |
|---|---|---|---|---|---|---|---|---|---|---|---|---|
| Sample | Mn | C | V | Cr | Ni | Si | Cu | Al | S | P | Others | Fe |
| CRCS A | 0.50 | 0.129 | 1.51 | 0.004 | 0.003 | 0.113 | 0.001 | 0.007 | 0.008 | 0.002 | 0.0100 | Bal |
| (1.5 V) | | | | | | | | | | | | |
| CRCS B | 0.49 | 0.119 | 2.51 | 0.006 | 0.003 | 0.115 | 0.001 | 0.004 | 0.008 | 0.002 | 0.0120 | Bal |
| (2.5 V) | | | | | | | | | | | | |
| AISI 1018 | 0.72 | 0.186 | 0.0008 | 0.053 | 0.064 | 0.223 | 0.182 | 0.03 | 0.022 | 0.006 | 0.0486 | Bal |
| ASTM | 0.65 | 0.237 | 0.0013 | 0.038 | 0.01 | 0.245 | 0.012 | 0.018 | 0.009 | 0.013 | 0.0248 | Bal |
| A106 B | | | | | | | | | | | | |
| ASTM | 0.72 | 0.150 | 0.0019 | 0.172 | 0.194 | 0.211 | 0.293 | 0.024 | 0.004 | 0.015 | 0.0932 | Bal |
| A516 Gr 55 | | | | | | | | | | | | |

It is seen from FIG. 2 that the corrosion behavior of CRCS materials is distinct from the reference materials. Although the corrosion rates for all the materials appear similar near the beginning of the test, performance difference becomes evident after a week of exposure. The AISI 1018 and ASTM A106 B materials showed a trend toward increasing corrosion rates with time. The corrosion rate of ASTM A516 Grade 55 slightly decreased initially, but then after 40 days trended toward increasing corrosion rate. The corrosion rate of CRCS grades, in contrast, after initial few days they continuously trended downward with time. At the end of the test, the instantaneous corrosion rates of both CRCS materials were lowest among the five materials, and were further trending to even lower corrosion rates.

TABLE 2
Average corrosion rates (mils per year)

| | LPR | LPR | LPR | |
|---|---|---|---|---|
| | Wet Cycle | Dry Cycle | Weighted | Weight |
| Material | Avg | Avg | Avg | Loss |
| CRCS Steel A | 0.55 | 0.16 | 0.67 | 1.72 |
| (1.5% V) | | | | |
| CRCS Steel B | 1.49 | 3.5 | 1.88 | 4.97 |
| (2.5% V) | | | | |
| AISI 1018 | 4.11 | 6.65 | 4.47 | 8.07 |
| ASTM A106-B | 2.7 | 5.37 | 3.19 | 4.46 |
| ASTM A516 Gr | 0.5 | 1.09 | 0.57 | 5.51 |
| 55 | | | | |

Table 2 lists the average corrosion rate for the materials over the duration of the test. The 1.5% V CRCS material is found to have the lowest average weight loss corrosion rate. The performance of 2.5% V CRCS and the A516 Gr 55 material is similar, while the A106 Grade B material showed poorer behavior via UR monitoring, but similar performance when considering weight loss alone. The AISI 1018 grade was the poorest performer by all measures. Visual inspection of the specimen after the test indicated that the 1,5% V CRCS had the least amount of localized crevice corrosion of all the materials tested—18% of its surface area was affected by localized corrosion as compared to 40% for the 2.5% V CRCS, A106-B and A516 Grade 55 materials. These results evidence a performance advantage for the CRCS grade material over the base case carbon steels.

PCT and EP Clauses:

1. A method for inhibiting corrosion under insulation (CUI) on the exterior of a structure, said method comprising providing a structure that is at least partially formed from a corrosion resistant carbon steel (CRCS) composition; wherein said CRCS composition comprises corrosion resistance alloying additions in the amount of 0.1 weight percent to 9 weight percent.

2. The method of clause I wherein said CRCS composition comprises at least one alloying addition having a low free energy of formation for its oxide and/or hydroxide.

3. The method of clause 2 wherein said at least one alloying addition having a low free energy of formation for its oxide and/or hydroxide comprises vanadium and/or titanium.

4. The method of clauses 1-3 wherein the CRCS composition comprises one of vanadium in an amount of 0.1 weight percent to 9 weight percent; carbon in an amount of 0.03 weight percent to 0.45 weight percent; manganese in an amount up to 2 weight percent; chromium in an amount less than 5 weight percent; silicon in an amount up to 0.45 weight percent; and with the balance being iron and minor amounts of impurities.

5. The method of clauses 1-4 wherein the CRCS composition comprises vanadium in an amount of 1 weight percent to 6 weight percent, and a combination of chromium and vanadium in an amount of 0.1 weight percent to 9 weight percent.

6. The method of clauses 1-5 wherein the CRCS composition has a steel microstructure that comprises of one of the following: predominantly ferrite, martensite, tempered martensite, dual phase ferrite and martensite, and dual phase ferrite and tempered martensite.

7. The method of clauses 1-6 wherein the structure comprises a pipeline, a pipe, a vessel and/or a tank.

8. The method of clauses 1-7 wherein the insulation is selected from the group consisting of per lite, aeroge s cellular glass, mineral wool, and calcium silicate.

9. The method of clauses 1-8 wherein the structure is formed by providing a CRCS composition, the CRCS composition comprising: vanadium in an amount of 0.1 weight percent to 9 weight percent; carbon in an amount of 0.03 weight percent to 0.45 weight percent; manganese in an amount up to 2 weight percent; silicon in an amount up to 0.45 weight percent; and the balance being iron and minor amounts of impurities; annealing the CRCS composition at a suitable temperature and for a suitable time period to substantially homogenize the CRCS composition and dissolve precipitates; and suitably quenching the CRCS composition to produce one of predominantly ferrite microstructure, predominantly martensite microstructure and predominantly dual phase microstructure.

10. The method of clauses 1-9 Wherein the annealing temperatures are in the range from 850° C. to 1450° C. and annealing times are up to 24 hours.

11. The method of clause 8 wherein the CRCS composition is further subjected to tempering temperatures between 400° C. and the austenite formation temperature for up to 12 hours.

12. A corrosion inhibited structure comprising: a) a structure that is at least partially formed from a corrosion resistant carbon steel (CRCS) composition, wherein said CRCS composition comprises corrosion resistance alloying additions in the amount of 0.1 weight percent to 9 weight percent; and b) insulation positioned around at least a portion of the structure.

13. The structure of clause 12 wherein said CRCS composition comprises at least one alloying addition having a low free energy of formation for its oxide and/or hydroxide.

14. The structure of clause 13 wherein said at least one alloying addition having a low free energy of formation for its oxide and/or hydroxide comprises vanadium and/or titanium.

15. The structure of clauses 12-14 wherein the CRCS composition comprises vanadium in an amount of 0A weight percent to 9 weight percent; carbon in an amount of 0.03 weight percent to 0.45 weight percent; manganese in an amount up to 2 weight percent; chromium in an amount less than 5 weight percent; silicon in an amount up to 045 weight percent; and with the balance being iron and minor amounts of impurities.

Applicants have attempted to disclose all embodiments and applications of the disclosed subject matter that could be reasonably foreseen. However, there may be unforeseeable, insubstantial modifications that remain as equivalents. While the present invention has been described in conjunction with specific, exemplary embodiments thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A method for inhibiting corrosion under insulation (CUI) on the exterior of a structure, said method comprising:
providing a structure that is at least partially formed from a corrosion resistant carbon steel (CRCS) composition, wherein said CRCS composition comprises corrosion resistance alloying additions in the amount of 0.1 weight percent to 9 weight percent.

2. The method of claim 1 wherein said CRCS composition comprises at least one alloying addition having a low free energy of formation for its oxide and/or hydroxide.

3. The method of claim 2 wherein said at least one alloying addition having a low free energy of formation for its oxide and/or hydroxide comprises vanadium and/or titanium

4. The method of claim 1 wherein the CRCS composition comprises one of vanadium in an amount of 0.1 weight percent to 9 weight percent; carbon in an amount of 0.03 weight percent to 0.45 weight percent; manganese in an amount up to 2 weight percent; chromium in an amount less than 5 weight percent; silicon in an amount up to 0.45 weight percent; and with the balance being iron and minor amounts of impurities.

5. The method of claim 4 wherein the CRCS composition comprises vanadium in an amount of 1 weight percent to 6 weight percent.

6. The method of claim 4 wherein the CRCS composition comprises a combination of chromium and vanadium in an amount of 0.1 weight percent to 9 weight percent.

7. The method of claim 4 wherein the CRCS composition has a steel microstructure that comprises of one of the following: predominantly ferrite, martensite, tempered martensite, dual phase ferrite and martensite, and dual phase ferrite and tempered martensite.

8. The method of claim 7 wherein the steel microstructure further comprises precipitates.

9. The method of claim 1 wherein the structure comprises a pipeline, a pipe, a vessel and/or a tank.

10. The method of claim 1 wherein the insulation is selected from the group consisting of perlite, aerogels, cellular glass, mineral wool, and calcium silicate.

11. The method of claim 1 wherein the structure is formed by:
providing a CRCS composition, the CRCS composition comprising: vanadium in an amount of 0.1 weight percent to 9 weight percent; carbon in an amount of 0.03 weight percent to 0,45 weight percent; manganese in an amount up to 2 weight percent; silicon in an amount up to 0.45 weight percent; and the balance being iron and minor amounts of impurities;
annealing the CRCS composition at a suitable temperature and for a suitable time period to substantially homogenize the CRCS composition and dissolve precipitates; and
suitably quenching the CRCS composition to produce one of predominantly ferrite microstructure, predominantly martensite microstructure and predominantly dual phase microstructure.

12. The method of claim 11 wherein the annealing temperatures are in the range from 850° C. to 1450° C. and annealing times are up to 24 hours.

13. The method of claim 11 wherein the CRCS composition is further subjected to tempering temperatures between 400° C. and the austenite formation temperature for up to 12 hours.

14. A corrosion inhibit structure comprising:
as a structure that is at least partially formed from a corrosion resistant carbon steel (CRCS) composition, wherein said CRCS composition comprises corrosion resistance alloying additions in the amount of 0.1 weight percent to 9 weight percent; and
b) insulation positioned around at least a portion of the structure.

15. The structure of claim 14 wherein said CRCS composition comprises at least one alloying addition having a low free energy of formation for its oxide and/or hydroxide.

16. The structure of claim 15 wherein said at least one alloying addition having a low free energy of formation for its oxide and/or hydroxide comprises vanadium and/or titanium.

17. The structure of claim 14 wherein the CRCS composition comprises vanadium in an amount of 0.1 weight percent to 9 weight percent; carbon in an amount of 0,03 weight percent to 0,45 weight percent; manganese in an amount up to 2 weight percent;
chromium in an amount less than 5 weight percent; silicon in an amount up to 0.45 weight percent; and with the balance being iron and minor amounts of impurities.

18. The structure of claim 17 wherein the CRCS composition comprises vanadium in an amount of 1 weight percent to 6 weight percent.

19. The structure of claim 17 wherein the CRCS composition comprises a combination of chromium and vanadium in an amount of 0.1 weight percent to 9 weight percent.

20. The structure of claim 17 wherein the CRCS composition has a steel microstructure that comprises of one of the following: predominantly ferrite, martensite, tempered martensite, dual phase ferrite and martensite, and dual phase ferrite and tempered martensite.

21. The structure of claim 14 which comprises a pipeline, a pipe, a vessel and/or a tank.

22. The structure of claim 14 wherein the insulation is selected from the group consisting of perlite, aerogels, cellular glass, mineral wool, and calcium silicate.

23. The structure of claim 14 which is formed by:
providing a CRCS composition, the CRCS composition comprising: vanadium in an amount of 0.1 weight percent to 9 weight percent; carbon in an amount of 0.03 weight percent to 0.45 weight percent; manganese in an amount up to 2 weight percent; silicon in an amount up to 0.45 weight percent; and the balance being iron and minor amounts of impurities;
annealing the CRCS composition at a suitable temperature and for a suitable time period to substantially homogenize the CRCS composition and dissolve precipitates; and
suitably quenching the CRCS composition to produce one of predominantly ferrite microstructure, predominantly martensite microstructure and predominantly dual phase microstructures.

24. The structure of claim 23 wherein the annealing temperatures are in the range from 850° C. to 1450° C. and annealing times are up to 24 hours.

25. The structure of claim 23 wherein the CRCS composition is further subjected to tempering temperatures between 400° C. and the austenite formation temperature for up to 12 hours.
